(19) United States
(12) Patent Application Publication
(10) Pub. No.: US 2004/0190855 A1
(43) Pub. Date: Sep. 30, 2004

(54) Method for transmitting movie segment information

(75) Inventor: Thomas Poslinski, San Diego, CA (US)

Correspondence Address: FITCH EVEN TABIN AND FLANNERY, 120 SOUTH LA SALLE STREET, SUITE 1600, CHICAGO, IL, 60603-3406, US

(73) Assignees: Sony Corporation,, Tokyo (JP); a Japanese corporation and Sony Electronics Inc., Park Ridge, NJ; a Delaware Corporation

(21) Appl. No.: 10/404,605

(22) Filed: Mar. 31, 2003

(51) Int. Cl. H04N 5/76; H04N 5/781

(52) U.S. Cl. 386/46; 386/125

(57) ABSTRACT

A method comprising receiving a video signal over a first communication channel; storing the video signal in a memory of a digital recorder; receiving video segment information over the first communication channel; and storing the video segment information in the memory of the digital recorder. The digital recorder can output a video signal to a television as a visual segment table which provides a user with chapter information for the video signal.

### BACKGROUND OF THE INVENTION

1. Field of the Invention

The present invention relates to the transmission of video signals, and more specifically to the transmission and recording of video signals. Even more specifically, the present invention relates to transmission of a video signal and video segment information where the video signal and video segment information are stored by a digital recorder.

2. Discussion of the Related Art Television broadcasts have been around for many years. Additionally, the ability for a user to record these broadcasts can be easily accomplished with a VCR. More recently, digital recorders have become much more popular. One example of a digital recorder is the SVR-3000 Digital Network Recorder available from SONY at www.sony.com. These recorders allow a user to play back a television show or movie at a later time. However, if the user wishes to start the television show or movie at a place other than the beginning, the user must fast forward and try and find the desired starting place.

What is needed is a movie recorder which can store television shows or movies while also storing video segment information such that a user can select a desired chapter from which to start the television show or movie. The present invention advantageously addresses the above and other needs.

### SUMMARY OF THE INVENTION

The present invention advantageously addresses the needs above as well as other needs by providing a system and method for storing movie segment information on a digital recorder.

In one embodiment, the invention can be characterized as a method comprising receiving a video signal over a first communication channel; storing the video signal in a memory of a digital recorder; receiving video segment information over the first communication channel; and storing the video segment information in the memory of the digital recorder.

In another embodiment, the invention can be characterized as a method comprising receiving a video signal over a first communication channel; storing the video signal in a memory of a digital recorder; receiving video segment information over a second communication channel; and storing the video segment information in the memory of the digital recorder.

In a further embodiment, the invention can be characterized as an apparatus comprising a digital recorder configured to: store a video signal received over a first communication channel; store video segment information received over the first communication channel; and output a video signal representing the video segment information.

In a subsequent embodiment, the invention can be characterized as an apparatus comprising a digital recorder configured to: store a video signal received over a first communication channel; store video segment information received over a second communication channel; and output a video signal representing the video segment information.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a block diagram illustrating a hardware system in accordance with one embodiment of the present invention;

FIG. 2 is a block diagram illustrating a hardware system connected to a network in accordance with the present invention;

FIG. 3 illustrates one embodiment of displaying a visual segment table in accordance with the embodiments shown in FIGS. 1 and 2;

FIG. 4 illustrates one embodiment of relationship between the visual segment table of FIG. 3 and a movie;

FIG. 5 is a flowchart illustrating a method of receiving video segment information in accordance with the embodiment shown in FIG. 1; and

FIG. 6 is a flowchart illustrating a method of receiving video segment information in accordance with the embodiment shown in FIG. 2.

Corresponding reference characters indicate corresponding components throughout the several views of the drawings.

### DETAILED DESCRIPTION OF THE PREFERRED EMBODIMENTS

The following description of the presently contemplated best mode of practicing the invention is not to be taken in a limiting sense, but is made merely for the purpose of describing the general principles of the invention. The scope of the invention should be determined with reference to the claims.

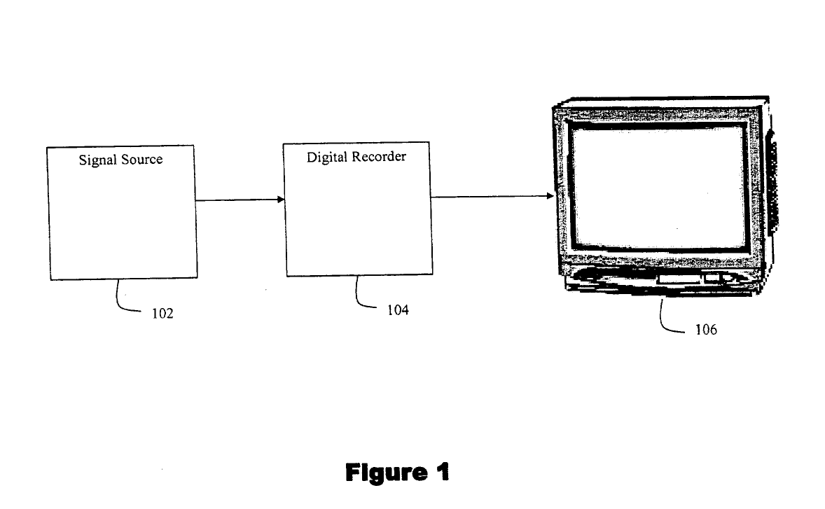

Referring first to FIG. 1, shown is a signal source 102, a digital recorder 104, and a display monitor 106. The digital recorder 104 is electronically connected between the signal source 102 and the display monitor 106.

In one embodiment, the digital recorder 104 receives a television signal from the signal source 102. At least part of the television signal is recorded and stored in a memory of the digital recorder 104. The digital recorder 104 also receives video segment information from the signal source. The video segment information is also stored in the memory of the digital recorder 104. Alternatively, the video segment information may be stored in a separate memory from the television signal.

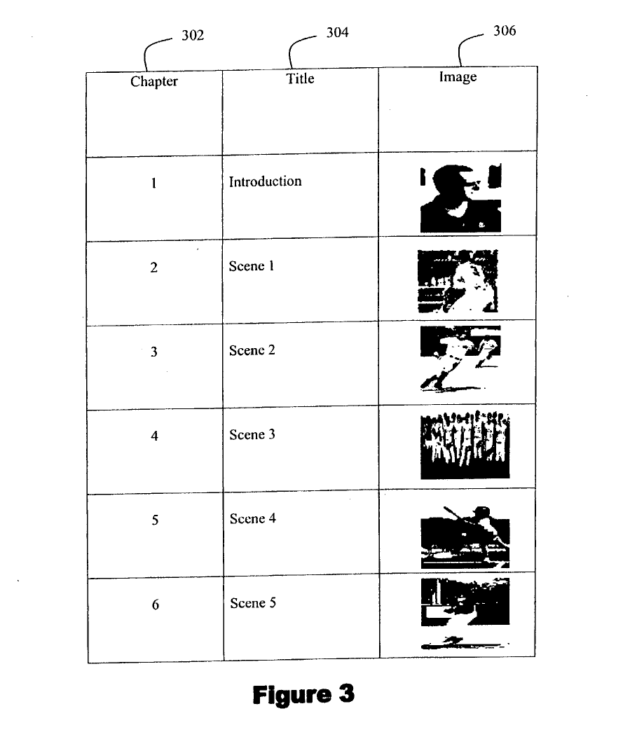

The video segment information contains information about the stored television signal. The video segment information may include one or more of the following: video identification parameters, video segment count, video segment titles, video segment frame offsets, video segment still picture frame offsets, and program time stamp offsets. The video segment information allows a user to jump directly to different chapters in the stored television signal. For example, the digital recorder 104 stores a television program in the memory. The digital recorder 104 also stores the video segment information in the memory. A user can view the video segment information through a visual segment table, such as is shown and described with reference to FIG. 3. The visual segment table allows the user to start watching the stored program from the beginning of any one of a plurality of chapters which are defined by the video segment information.

In one embodiment the video segment information can be a stream of serial data which provides the information for the visual segment table.

The video identification parameters can be either a reference number or a program title which identifies a program. The digital recorder or set-top-box can read the video identification parameter and retrieve the rest of the visual segment table based upon the video identification parameters. The video identification parameter can be the first entry in the visual segment table. In one embodiment, the video segment information is transmitted with an electronic program guide. In this embodiment, the electronic program guide will contain the video identification parameters, along with other program information for the program.

The video segment count is the number of chapters associated with the program identified by the video identification parameters.

The video segment titles are a title for each video segment count. This title can be in ASCII format. The video segment titles are associated with the chapter titles shown in FIG. 3.

The video segment frame offsets are an offset associated with each video segment count or video segment title. The video segment frame offsets are an integral number associated with the number of frames for each chapter. Frame zero is the first frame associated with the program stored on the digital recorder. For example the second chapter may be associated with the video segment frame offset 6000. This number represents the number of frames from the beginning of the program from which the second chapter will start. If the program content is transmitted in analog form, the exact frame offset in bytes of data will not be precisely known, but by counting frames, a relative frame offset for each chapter can be determined. Once you know the video frame offset for each chapter you can determine the chapter scene image 306, described in reference to FIG. 3, by searching for the first full frame of data, defined in MPEG-2 as an I-frame or key frame. The decoding of the first full frame of data will be the chapter scene image 306 associated wi the chapter defined by the video segment frame offset.

The video segment still picture frame offset is an optional data entry which can be used as a replacement for the video segment frame offset. Each video segment count or video segment title is optionally associated with the video segment still picture frame offset. The video segment still picture frame offset is specified as a number of bytes from the beginning of a file. For a digital video signal the byte offset into the file which has been stored on the digital recorder defines where the chapter scene image 306 can be found. The byte offset can define the chapter scene image 306 associated with each chapter. Additionally, the video segment still picture frame offset can define where the beginning of a chapter can be found.

The program time stamp offset is an optional data entry which can replace either the video segment frame offset or the video segment still picture frame offset. The program time stamp offset can be used for both analog and digital content streams. For each video segment count there can optionally be a program time stamp. The program time stamp offset can be defined in seconds or many other measurements of time. The beginning time of the stored program or movie on the digital recorder will have a time of zero. The program time stamp offset defines the number of seconds into the recorded program where the chapter scene image is stored. Additionally, the program time stamp offset can define where the beginning of a chapter can be found.

The signal source 102, which provides both the video signal and the video segment information in the embodiment shown in FIG. 1, can be a cable television signal. Alternatively, the signal source 102 can be many signals, including, but not limited to, a high definition digital television signal, a broadcast signal, and a satellite television signal. Additionally, the signal source 102 can be either a digital signal or an analog signal coming from a set-top box.

Digital recorders are known in the art. One example of a digital recorder is the SVR-3000 Digital Network Recorder available from SONY at www.sony.com. However as digital recorders become more popular, new value-add features will enhance the user experience. One way in which to enhance the user experience is to provide a digital recorder 104 which can store both video segment information and a video signal. The video segment information can be video chapters that allow the user to jump to specific locations in a television show. The video segment information can be recalled as a visual segment table, such as is shown in FIG. 3. In one embodiment, the video segment information is similar to a movie segment on a DVD. The movie segments separate the movie into predefined movie chapters. The present invention allows the user to acquire the movie segments of a broadcast movie that is recorded on the digital recorder 104. The user then has an enhanced viewing experience similar to watching a DVD.

For example, the signal source provides a video signal which is a movie and the video segment information is movie segment information. The movie is recorded by the digital recorder 104 which also stores the movie segment information corresponding to the movie. The movie segment information gives the user additional information about the movie and allows the user to jump from chapter to chapter as defined by the movie segment information. In one embodiment, a new chapter starts at the end of each commercial break, such that the user can easily skip over commercials during playback. In another embodiment, the chapters are predefined by the movie producers.

In the present embodiment, the movie segment information is transmitted in conjunction with the movie over a single broadcast channel. The movie segment information includes one or more of the following: movie identification parameters, movie segment count, movie segment titles, movie segment frame offsets, movie segment still picture frame offsets, and program time stamp offsets.

In one embodiment the movie segment information can be a stream of serial data which provides the information for the visual segment table.

The movie identification parameters can be either a reference number or a program title which identifies the movie or program. The digital recorder or set-top-box can read the movie identification parameter and retrieve the rest of the visual segment table based upon the movie identification parameters. The movie identification parameter can be the first entry in the visual segment table. In one embodiment, the movie segment information is transmitted with an electronic program guide. In this embodiment, the electronic program guide will contain the movie identification parameters, along with other program information for the movie or program.

The movie segment count is the number of chapters associated with the movie identified by the movie identification parameters.

The movie segment titles are a title for each movie segment count. This title can be in ASCII format.

The movie segment frame offsets are an offset associated with each movie segment count or movie segment title. The movie segment frame offsets are an integral number associated with the number of frames for each chapter. Frame zero is the first frame associated with the movie or program stored on the digital recorder. For example the second chapter may be associated with the movie segment frame offset 6000. This number represents the number of frames from the beginning of the movie from which the second chapter will start. If the movie content is transmitted in analog form, the exact frame offset in bytes of data will not be precisely known, but by counting frames, a relative frame offset for each chapter can be determined. Once you know the movie frame offset for each chapter you can determine the chapter scene image 306, described in reference to FIG. 3, by searching for the first full frame of data, defined in MPEG-2 as an I-frame or key frame. The decoding of the first full frame of data will be the chapter scene image 306 associated wi the chapter defined by the movie segment frame offset.

The movie segment still picture frame offset is an optional data entry which can be used as a replacement for the movie segment frame offset. Each movie segment count or movie segment title is optionally associated with the movie segment still picture frame offset. The movie segment still picture frame offset is specified as a number of bytes from the beginning of a file. For a digital video signal the byte offset into the file which has been stored on the digital recorder defines where the chapter scene image 306 can be found. The byte offset can define the chapter scene image 306 associated with each chapter. Additionally, the movie segment still picture frame offset can define where the beginning of a chapter can be found.

The program time stamp offset is an optional data entry which can replace either the movie segment frame offset or the movie segment still picture frame offset. The program time stamp offset can be used for both analog and digital content streams. For each movie segment count there can optionally be a program time stamp. The program time stamp offset can be defined in seconds or many other measurements of time. The beginning time of the stored program or movie on the digital recorder will have a time of zero. The program time stamp offset defines the number of seconds into the recorded program where the chapter scene image is stored. Additionally, the program time stamp offset can define where the beginning of a chapter can be found.

The digital recorder 104 stores both the movie and the movie segment information in the memory allowing a user of the digital recorder 104 to display an interactive visual segment table, such as is shown in FIG. 3, for the recorded movie. In one embodiment, the visual segment table includes a list of movie segments with a still frame picture from the movie representing a significant meaning to that chapter, such as the first frame of the chapter, or an important frame within the chapter. The user can then select which chapter to play. After the selection the digital recorder 104 will then start play at the frame offset and/or PTS offset reference from the beginning of the movie.

The transmission protocol used for the transmission of the movie segment information or the video segment information can be a simple table like format that includes redundant data and check sum capabilities for data integrity. Broadcasters can transmit the movie segment information or the video segment information both in analog format and digital format.

A video signal transmitted in analog format, e.g., the National Television Standard Committee (NTSC) standard, the Phase Alteration Lines (PAL) standard, or in the Sequential Couleur Avec Memoire (SECAM) standard, can encode the video segment information in the Vertical Blanking Interval (VBI) of the signal. The digital recorder 104 extracts the data before the analog video is digitized. Frame References and Programmable Time Stamps can also be encoded in the VBI for time reference used by the movie segment tables.

The video signal can also be transmitted in a digital format, e.g., digital-cable or a satellite broadcast. In this embodiment, the video segment information can be encoded in a digital form on a different PID (Program Identification Stream) than the video signal. A PID is a stream of serial data that is encoded using a known protocol so that known data can be extracted. Each of the included parameters in the video segment information has a known size which is understood by the digital recorder and which makes up the known protocol. Each packet of data includes a PID (Protocal ID) which identifies the type of data coming next. For example, the video signal has one PID which identifies it as the video signal while the video segment information has a second PID which identifies it as the video segment information.

Alternatively, video segment information for a program which is transmitted in a digital format by cable or satellite can be embedded in the video stream as defined by the video PID. The data can be enclosed in an auxiliary packet of the video stream. An MPEG-2 video stream uses a MPEG-2 protocol. The protocol uses PID packeting to transmit MPEG-2 data. The auxiliary packets have the same PID number as the video stream, however, the auxiliary packets do not contain video data, but typically contain access keys. The video segment information for a program can be concatenated with other data in the auxiliary packets. For example, the auxiliary stream can be used instead of the low bandwidth stream transmitted on a separate PID.

Video and audio data are transmitted on separate PIDs in the digital system. These PIDs are identified in a channel tuning table that is part of the digital system. The channel-tuning table also contain the PID value associated with a channel that is carrying the video segment information. The data stream containing the video segment information consists of a low-bit rate stream to minimize the overhead required. The bandwidth for the movie segment stream can be constant through out the entire movie, thus the movie segment stream can be re-transmitted many times throughout the entire movie. This allows for movie segment capabilities regardless of how much of the movie is recorded by the digital recorder 104. The information from the movie segment table is then stored along with the movie on the digital recorder 104.

The present invention is not limited to the type of transmission system used or the format in which the data for either the video signal or the video segment information is transmitted as many types of communication systems and data formats can be used in accordance with the present invention.

The display monitor 106 shown in FIG. 1 is a standard television set. The present invention is not limited to a standard television set and the display monitor 106 can be many types of viewing monitors, such as, but not limited to a liquid crystal display, a computer monitor, a lap top computer monitor, a projection television, a high definition television, and a flat panel television.

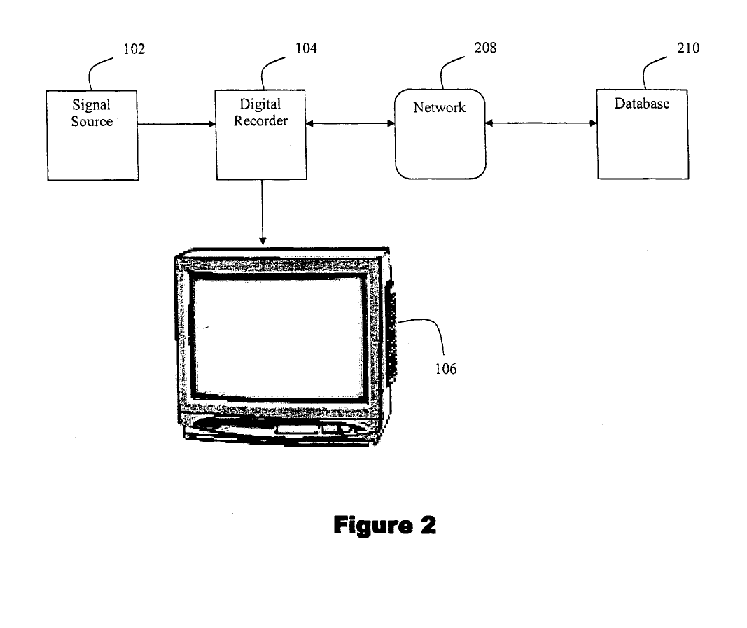

FIG. 2 illustrates a system in accordance with the present invention. Shown is the signal source 102, the digital recorder 104, the display monitor 106, a network 208, and a database 210. Similarly to the embodiment shown in FIG. 1, the digital recorder 104 receives a video signal from the signal source 102. The video signal can include a movie signal or other television programming signal.

The digital recorder 104 is connected through a modem to the network 208, e.g., the internet or a local area network (LAN). Video segment information can be downloaded from the database 210 for a video signal that has been recorded, or for which will be recorded in the future. The video segment information can be downloaded from a remote web site, such as, for example a web site related to the television signal. For example, if the movie “STAR WARS” was received by the digital recorder 104 and stored in the memory of the digital recorder 104, a web site related to “STAR WARS” could be accessed in order to obtain the video segment information. Alternatively, a web site or database of a provider of the signal source 102 can be accessed in order to receive the video segment information. For example, a cable television provider can have a web-site or database 210 that can be accessed by the digital recorder 104 to obtain the video segment information.

The video segment information can be transmitted, either over the network 208 or over the same communication channel as the signal source 102, along with other data such as program guide information that is typical with a digital broadcast system.

FIG. 3 illustrates one example of a visual segment table in accordance with the present invention. Shown is a plurality of chapter numbers 302, a plurality of chapter titles 304, and a plurality of chapter scene images 306. In accordance with the present invention, the visual segment table is displayed on the display monitor 106, such that a user can select one of the plurality of chapter numbers 302 which the user would like to view. The selection of one of the plurality of chapter number 302 is done by selecting any one of the plurality of chapter numbers 302, the plurality of chapter titles 304, and the plurality of chapter scene images 306. After the selection of the chapter number 302, the stored video signal corresponding to the selected chapter number 302 will be displayed on the display monitor 106. It should be clearly understood that the visual segment table can include additional information and the additional information can be selected in order to display a chapter. Additionally, as few as one of the plurality of chapter numbers 302, the plurality of chapter titles 304, and the plurality of chapter scene images 306 can be shown in the visual segment table.

As describe the video signal is broken up into chapters. The chapters are different sections or scenes of the video signal. For example, a movie may be broken up into 10 different chapters corresponding to logical separations of the parts of the movie. In another example a 30 minute television program may be broken up into 3 chapters, each corresponding to a 10 minute section of the television program. Optionally, each chapter may begin after the end of a commercial break.

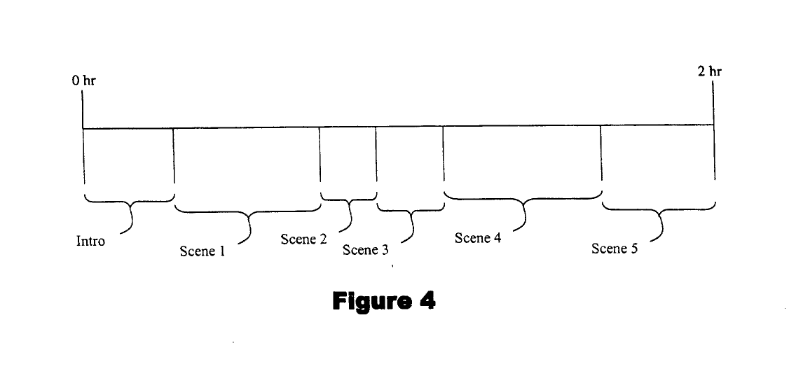

FIG. 4 illustrates a video signal with the plurality of a chapter titles associated with a plurality of sections of the video signal. As is shown, each of the plurality of sections of the video signal may be different sizes. As described above, each of the plurality of sections of the video signal can start directly after the end of a commercial break. Alternatively, the plurality of sections of the video signal can start in any convenient location within the video signal, e.g., the beginning of a new scene in a movie.

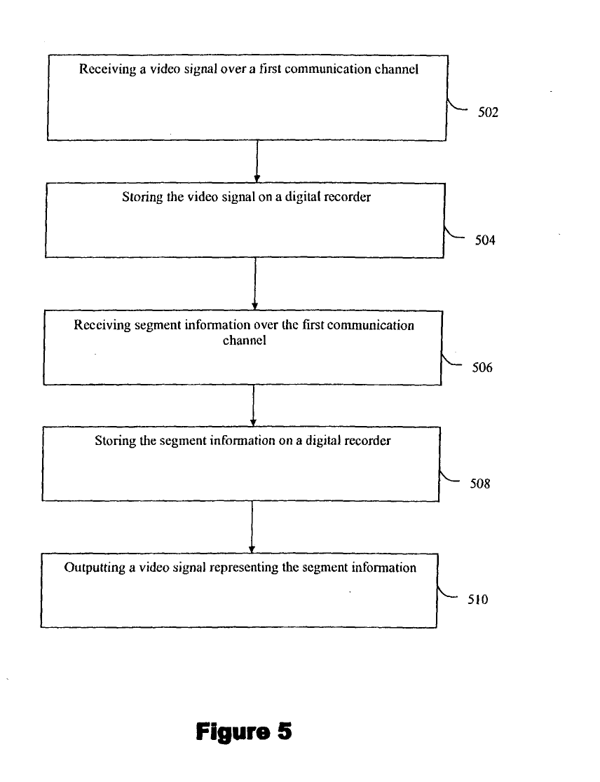

FIG. 5 illustrates a flow chart in accordance with the embodiment shown in FIG. 1. The digital recorder 104 receives a video signal over a first communication channel 502. The digital recorder 104 then stores at least a portion of the video signal 504. The digital recorder 104 next receives video segment information corresponding to the video signal over the first communication channel 506. The digital recorder 104 then stores at least a portion of the segment information 508. The digital recorder 104 can then output a video signal representing the stored portion of the segment information 510. The video segment information can be received and stored before, after, or simultaneously with the receipt and storage of the video signal.

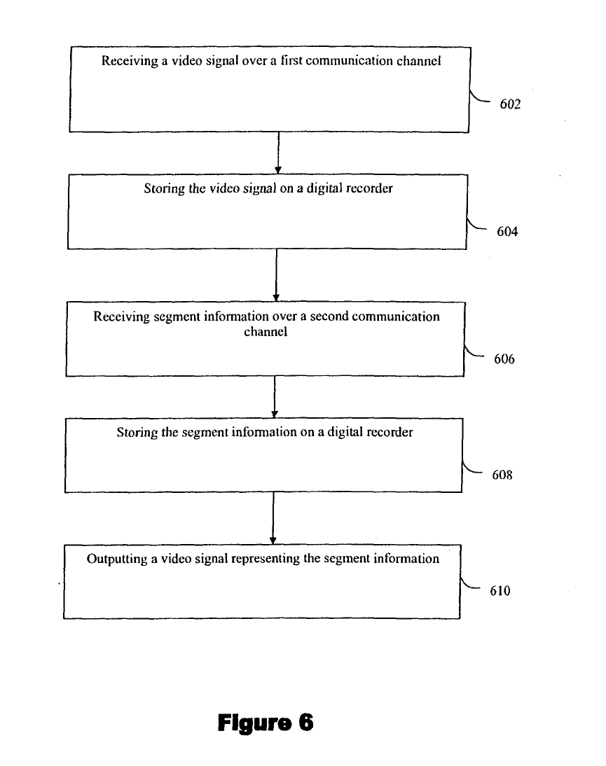

FIG. 6 illustrates a flow chart in accordance with the embodiment shown in FIG. 2.

The digital recorder 104 receives a video signal over a first communication channel 602. The digital recorder 104 then stores at least a portion of the video signal 604. The digital recorder 104 next receives video segment information corresponding to the video signal over a second communication channel 606. The digital recorder 104 then stores at least a portion of the video segment information 608. The digital recorder 104 can then output a video signal representing the stored portion of the segment information 610. It should be understood that the video segment information can be received and stored before or after the receipt and storage of the video signal.

In one embodiment the first communication channel is a cable television channel. Alternatively, for example, the first communication channel can be a broadcast television channel, or a satellite television channel. The second communication channel can be an internet connection. In this embodiment, the digital recorder 104 receives the video segment information through a communication channel that is connected to the internet. The digital recorder 104 can be directly connected to the internet through any type of modem. The modem can be built into the digital recorder 104 or can be a stand alone modem, such as a cable modem. Alternatively, the digital recorder 104 can receive the video segment information through a computer or set-top-box which is connected to the internet. In this embodiment, the computer or set-top box can access a web-site or remote database in order to obtain the video segment information.

Thus, in accordance with the invention described herein, a user can watch a movie that has been broadcast over a communication channel and recorded on a digital recorder 104. The user can view a visual segment table and select a chapter of the movie from which to begin playback of the movie. Thus, if the user has previously watched a portion of the movie the user will not have to “fast forward” to attempt to return to the last portion of the movie they watched. The user can view the visual segment table and select one of the chapters from which they would like to begin playback. As the visual segment table can include a chapter scene image the user can easily identify a chapter from which to start playback of the recorded movie. The video segment information gives the user of the digital recorder much more control of the playback of a video signal than previously available from the recording of a broadcast signal.

While the invention herein disclosed has been described by means of specific embodiments and applications thereof, numerous modifications and variations could be made thereto by those skilled in the art without departing from the scope of the invention set forth in the claims.

What is claimed is:

1. A method comprising:
receiving a video signal over a first communication channel;
storing the video signal in a memory of a digital recorder;
receiving video segment information over the first communication channel; and
storing the video segment information in the memory of the digital recorder.

2. The method of claim 1 further comprising outputting a signal corresponding to a visual segment table.

3. The method of claim 2 further comprising displaying the visual segment table.

4. The method of claim 1 wherein the video signal is a movie.

5. The method of claim 1 further comprising outputting the video signal.

6. The method of claim 1 wherein the video segment information is received with program guide information.

7. A method comprising:
receiving a video signal over a first communication channel;
storing the video signal in a memory of a digital recorder;
receiving video segment information over a second communication channel; and
storing the video segment information in the memory of the digital recorder.

8. The method of claim 7 further comprising outputting a signal corresponding to a visual segment table.

9. The method of claim 8 further comprising displaying the visual segment table.

10. The method of claim 7 wherein the video signal is a movie.

11. The method of claim 7 wherein the second communication channel is a computer network.

12. An apparatus comprising:
a digital recorder configured to:
store a video signal received over a first communication channel;
store video segment information received over the first communication channel; and
output a signal representing the video segment information.

13. The apparatus of claim 12 further comprising a display monitor coupled to the digital recorder.

14. The apparatus of claim 12 wherein the digital recorder is configured to output a signal corresponding to a visual segment table.

15. The apparatus of claim 12 wherein the video signal is a movie signal.

16. The apparatus of claim 12 wherein the communication channel is a broadcast channel.

17. The apparatus of claim 12 wherein the communication channel is a cable television channel.

18. An apparatus comprising:
a digital recorder configured to:
store a video signal received over a first communication channel;
store video segment information received over a second communication channel; and
output a video signal representing the video segment information.

19. The apparatus of claim 18 further comprising a display monitor coupled to the digital recorder.

20. The apparatus of claim 18 wherein the digital recorder is configured to output a signal corresponding to a visual segment table.

21. The apparatus of claim 18 wherein the first communication channel is a television communication channel.

22. The apparatus of claim 21 wherein the second communication channel is a computer network.
